(19) United States
(12) Patent Application Publication
(10) Pub. No.: US 2026/0106877 A1
(43) Pub. Date: Apr. 16, 2026

(54) QUANTUM KERNEL ENHANCED DEEPFAKE DETECTION AND PREVENTION

(71) Applicant: American Express Travel Related Services Company, Inc, New York, NY (US)

(72) Inventors: Hiranmayi PALANKI, Tampa, FL (US); John Thomas HANCOCK, III, Deerfield Beach, FL (US)

(73) Assignee: American Express Travel Related Services Company, Inc, New York, NY (US)

(21) Appl. No.: 18/916,434

(22) Filed: Oct. 15, 2024

(51) Int. Cl. H04L 9/40; G06N 10/60

(52) U.S. Cl. CPC H04L 63/1416; G06N 10/60; H04L 63/08

(57) ABSTRACT

System, method, and computer program product embodiments detect synthetic media known as deepfakes based on received inferencing data that includes content such as a file or stream of audio, image, video, or textual chat data. The inferencing data further includes inferencing metadata associated with a source of the content. A data vector derived from one or more samples of the content and the inferencing metadata is transmitted to quantum computing hardware for quantum amplitude encoding of the data vector into a set of qubits, which are processed with a trained quantum support vector machine (SVM) to produce a classification of the content as synthetic or genuine. Based on a signal indicating that the content is synthetic, a notification or alert is generated and sent to a human user or an automated system warning that the content is classified as including deepfake data.

### BACKGROUND

### Field

This application generally relates to systems for detecting and preventing the user of synthetic media, and in particular to quantum kernel enhanced synthetic media detection and prevention.

### Related Art

A deepfake is a file or stream comprising synthetic media algorithmically generated or manipulated from real media sources using deep learning models to convincingly simulate or impersonate a real or non-existent person. Media data in a deepfake file or stream can include video, audio, still imagery, textual data, other modalities of media data, or combination of these. Deepfakes can be created, for example, using machine learning (ML) and artificial intelligence (AI) techniques, including facial recognition algorithms and artificial neural networks such as variational autoencoders (VAEs) and generative adversarial networks (GANs). As an example, a deepfake can appear to evidence a person saying or doing something that the person did not really say or do, with potential financial, legal, or societal consequences.

### BRIEF SUMMARY

Disclosed herein are system, apparatus, device, method and/or computer program product embodiments, and/or combinations and sub-combinations thereof, for training and inferencing of a deepfake detection classifier model capable of determining whether inferencing data, which can include media data and/or multimodal data, is genuine or synthetic. Computer-implemented methods, systems, and non-transitory computer-readable devices as described herein can make use of quantum computing to provide speed advantages, can incorporate a variety of source-associated metadata as deepfake indicators of compromise, can implement unlearnable example and differential privacy techniques to preserve privacy in privacy-sensitive training data, and can use adversarial training techniques to enhance classifier model training. System, method, and computer program product embodiments as described herein can be employed to address problems associated with deepfake-based misinformation or disinformation propagating in social media, and/or to protect the integrity of enterprise organization computer systems by hardening them against deepfake-based authentication or authorization attacks, thus reducing costs associated with cyberfraud and reputational damage.

### BRIEF DESCRIPTION OF THE DRAWINGS

The accompanying drawings are incorporated herein and form a part of the specification.

FIG. 1 is a flow diagram illustrating an example deepfake detection model training and deployment method.

FIG. 2 is a flow diagram illustrating an example hybrid privacy protection method for deepfake detection model training data.

FIG. 3 is a flow diagram illustrating an example quantum Fourier transform method for cloaking media.

FIG. 4 is a block diagram illustrating an example quantum Fourier transform circuit for cloaking media.

FIG. 5 is a flow diagram illustrating an example method of quantum support vector machine training or inferencing.

FIG. 6 is a block diagram illustrating an example arrangement for quantum deepfake detection model training and/or testing, and production use.

FIG. 7 is a flow diagram illustrating an example method of deepfake detection using quantum amplitude encoding.

FIG. 8 is a flow diagram illustrating an example method of quantum generative adversarial network training.

FIG. 9 is a flow diagram illustrating an example method of quantum deepfake detection.

FIG. 10 is a block diagram illustrating an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof for training and inferencing of a deepfake detection classifier model capable of determining whether inferencing data, which can include media data and/or multimodal data, is genuine or synthetic.

As synthetic media technology develops and the verisimilitude of deepfakes increases, synthetic media pose growing threats to individuals, businesses, governments, social fabrics, and economies when used for hoax or financial fraud purposes, as examples. Threats from deepfakes, which include bypassing biometric authentication and impersonating others over videoconferencing, present a growing challenge for the financial sector, for example. With the advent of generative AI, easy-to-use deepfake creation techniques are more widely and less expensively available to malicious cyber actors, increasing the frequency and sophistication of deepfake attacks. Deepfake fraud is an emerging category of fraud that current solutions have not addressed across modalities. Many existing fraud detection solutions are siloed. For example, many existing solutions for account takeover attack detection and credential-stuffing attack detection do not consider the threat of deepfakes in their pattern recognition and AI/ML techniques. On the other hand, existing deepfake detection solutions do not consider account takeover or credential stuffing attacks that may be perpetuated by threat actors in parallel in a single payment transaction. Existing deepfake detection capabilities tend to be domain-specific, addressing just audio, or just text. Moreover, existing deepfake detection capabilities can be bypassed. If a deepfake detection model is not trained on a certain type of a data set, it may not be able to generalize well across unseen deepfakes, for example. The systems, methods, and computer-readable media described herein can offer a comprehensive, holistic training technique that can address these and other deficiencies found in existing fraud detection and prevention techniques.

Threat adversaries using deepfakes may especially target customers, personnel (e.g., employees, contractors, and consultants), and highly-placed management executives (e.g., officers, directors, board members, etc.) in positions of authority or power. C-suite-level executives can present especially enticing targets for threat adversaries, because information accessible only by acquiring credentials having C-suite executive privileges can be especially sensitive and valuable, and creating hoax media that can be falsely perceived to present statements or actions of such individuals can be especially reputationally damaging to the targeted individual or the enterprise organization's brand image and thus can have outsized effects on consumer and investor confidence and stock prices. The systems, methods, and computer-readable media described herein can be configured to provide security to media representing individuals, including customers, personnel, and executives, providing additional advantages over existing deepfake solutions.

In some embodiments, therefore, the systems, methods, and computer-readable devices described herein may receive inferencing data comprising a file or stream comprising at least one of audio data, image data, video data, or textual chat data, and inferencing metadata associated with a source of the file or stream. A data vector derived from one or more samples of the file or stream and the inferencing metadata can be transmitted to quantum computing hardware configured to perform quantum amplitude encoding of the data vector into a set of qubits, which can be processed with a trained quantum support vector machine to produce a classification of the set of qubits as indicating that the file or stream is one of synthetic or genuine. Based on a signal indicating that the classification made by the quantum support vector machine is indicative that the file or stream is synthetic, the systems, methods, and computer-readable devices described herein can generate a notification or alert to a human user or an automated system warning that the file or stream is classified as including (e.g., likely includes) deepfake data.

In some examples, the systems, methods, and computer-readable devices described herein can enable deepfake detection model training that is based on deepfake indicators of compromise. Training metadata can be collected from a variety of sources, as described in greater detail below. Training data, including the training metadata, can be filtered and preprocessed to better secure the privacy of sensitive information in the training data. The preprocessing can implement a hybrid approach that includes both unlearnable examples privacy techniques and differential privacy techniques. The filtered and preprocessed training data can be used to train a deepfake detection model implemented, for example, as a quantum support vector machine, trained using quantum computing hardware. In such examples, the training data can be encoded into qubits using quantum amplitude encoding. In some examples, the training data can be supplemented with synthetic data generated by a quantum generator circuit trained using a quantum generative adversarial network process.

In some examples, the systems, methods, and computer-readable devices described herein can include deployment of a trained deepfake detection model as part of a social network system or customer service call center or chatbot. The trained deepfake detection model can address problems of dissemination of deepfake misinformation or disinformation on the social network, or can address problems associated with cyberfraud and unauthorized data access in data systems that may rely on media-based authentication, such as voice authentication, video-based face authentication, textual chat style authentication, or combinations thereof.

In some examples, the systems, methods, and computer-readable devices described herein can provide cloaking of media files or streams to inhibit or prevent the media files or streams from being used to train deepfake generation systems. The cloaking can be performed using quantum computing to realize speed advantages. In this way, future deepfakes can be prevented from being created based on the cloaked media files or streams.

Various embodiments of these features are discussed with respect to the corresponding figures.

### Deepfake Indicators of Compromise

Embodiments as described herein can use certain data attributes or combinations of data attributes as deepfake indicators of compromise. These attributes can include the following information as associated with a media file or stream. During a training phase, the attributes can be associated with a known or probable deepfake media file or stream and used as training or validation inputs for the training of a deepfake detection model. The deepfake detection model can, in some examples, be a quantum support vector machine. During a detection phase, the attributes can be associated with a suspected or potential deepfake media file or stream and used as inputs to a deepfake detection model. The attributes can include (a) a source Internet Protocol (IP) address; (b) a domain name, and/or WHOIS data associated with the domain name, and/or X.509 certificate information associated with the domain name; (c) a uniform resource locator (URL), and/or website, and/or repository (e.g., Github repository); (d) one or more request parameters (e.g., headers, cookies, body); (e) telemetry from a jailbroken, rooted, or tampered mobile device or a rogue mobile device application (“app”); (f) attempted phishing indicators (e.g., hidden form fields, obfuscated JavaScript code); (g) attempted attack indicators, such as data indicative of brute force attacks, account takeover attacks, credential stuffing, and/or credential cracking; (h) an IP or telephone number reputation indicator, a bot indicator, a Tor indicator, a virtual private network (VPN) indicator, an autonomous system number (ASN) indicator, and/or a user agent indicator; (i) failed authentication, authorization attempts, and/or tampered JavaScript Object Notation Web Token (JWT) tokens; and (j) a file or stream hash value. One or more of these factors can be used, for example, to fingerprint the IP address or domain name of a potential phishing domain or a rogue domain where misinformation or disinformation synthetic media might be created or published.

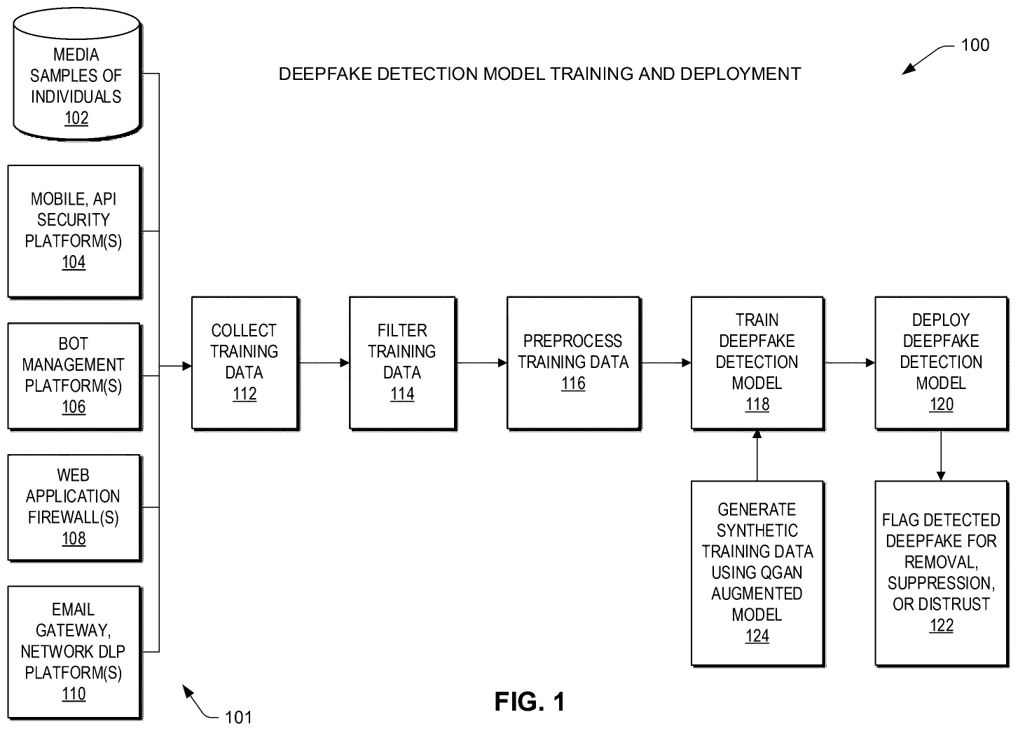

One or more data collection computer systems can be configured to capture and collect the above data, such as IP addresses, domains, URL, websites, repositories, and/or others of the data attributes. The data can be captured and collected from, as examples, a security platform 104 of a mobile application system and/or an application programming interface (API), from a bot management platform 106, from a web application firewall 108, and/or from one or more email gateways and/or network data loss prevention (DLP) platforms 110, as shown in FIG. 1. In some examples, the same or another one or more computer systems can compute one or more metrics related to deepfake indicators of compromise based on the captured and collected data. In some examples, the captured and collected data can be used to train a deepfake detection model.

One or more of the above-listed attributes, provided as metadata associated with a media file or stream, can serve as deepfake indicators of compromise by indicating a correlation between known deepfake, misinformation, or disinformation data and a publication or transmission source of suspected deepfake data. The publication or transmission source can be, as examples, one or more websites, URLs, phone numbers, IP addresses, and/or geographical locations. Reputation score data or telemetry data can thus be associated with such data provided as metadata associated with suspected deepfake data. This metadata can be used, in effect, as circumstantial evidence that suspected deepfake data is accurately assessed as deepfake data. A deepfake classifier model, e.g., a quantum support vector machine (SVM), can be trained using deepfake indicators of compromise as training data to better perform classification of media as genuine or synthetic and thus to alert to dangerous deepfake content.

The relevance of any one or more of the above-described deepfake indicators of compromise can be highly use case dependent. Some of the above attributes may be more applicable than others in different deepfake detection scenarios. As examples, in a scenario in which a video posted to social media is tested for deepfake indicators of compromise, or in a scenario in which a voice stream to a customer service call center is tested for deepfake indicators of compromise, there may or may not be relevant attempted phishing or attack indicators or failed authentication indicators. In a scenario involving an attempt to bypass a voice biometric system over a telephone call, voice over IP (VoIP) call, or internet videoconference call, relevant deepfake indicators of compromise may include telemetry from a jailbroken, rooted, or tampered mobile device or a rogue mobile app, or IP or telephone number reputation indicative that the voice stream originates from a blacklisted set of IP addresses or telephone numbers known or suspected to belong to a rogue domain. In a scenario involving a deepfake sent via a phishing email, relevant deepfake indicators of compromise can include URL, domain, and/or IP address of origin of the email. Thus, different subsets of the above-described indicators of compromise may be more or less relevant depending on the particular deepfake use case.

In contrast to deepfake detection models trained only on certain sets of images, videos, audio recordings, or textual data, in examples described herein, comprehensive training datasets can include the above deepfake indicators of compromise as training data to a deepfake detection model. A deepfake detection model as described herein can be trained on a dark web dataset, which can include stolen or counterfeit credit card numbers, ransomware distributions, malware distributions, zero-day exploit distributions, hacking attempt data, and cryptocurrency data. A deepfake detection model as described herein can be trained on an authentication (authn) and authorization (authz) attacks dataset, which can include data regarding past account takeover attacks, credential stuffing attacks, credential cracking attacks, password spraying attacks, and/or brute force attacks. A deepfake detection model as described herein can be trained on an API attack dataset, which can include data regarding failed API authentication attempts, failed authorization attempts, tampered JWT tokens, request parameters (headers, cookies, body), IP and/or telephone number reputation, bot, Tor, VPN, ASN, and user agents.

A deepfake detection model as described herein can be trained on a phishing dataset, which can include IP address data, domain name data, WHOIS data, and/or X.509 certificate information for IP addresses or domains ascertained to be associated with phishing activity, as well as information pertaining to a URL, website, or repository where deepfakes are published. A deepfake detection model as described herein can be trained on a mobile attack dataset, which can include jailbroken, rooted, or tampered mobile device telemetry, and/or rogue mobile app information. Such information can be useful in determining whether communications originate from or have transited through a compromised hardware device or a hardware device running compromised software.

A deepfake detection model as described herein can be trained on customer, personnel, or executive image, audio, and video datasets, which can include images, audio recordings, and video recordings of legitimate internal organizational media and/or externally published media of customers, personnel, and/or executives associated with an enterprise organization. Properly labeled as such, certain ones of these media files or streams can represent legitimate recordings of human individuals, which can represent non-deepfake examples to serve as negative class data in training data used to train the deepfake detection model. Properly labeled as such, others of these media files or streams can represent deepfake examples to serve as positive class data in the training data used to train the deepfake detection model.

A deepfake detection model as described herein can be trained on a biometrics dataset, which can include identity verification data, e.g., data derived from fingerprint identity verification systems, facial identity verification systems, voice identity verification systems, retinal scan identity verification systems, textual style identity verification systems, and others. The biometrics dataset can further include heart rate, gait, and breathing information, e.g., sourced from wearable devices, which can also be used to verify identity.

A deepfake detection model as described herein can be trained on a network DLP dataset, which can include information pertaining to sensitive data exfiltration to rogue domains. A network DLP dataset can include various types of network traffic data, including normal traffic data describing legitimate data transfers and communication patterns within a network; malicious traffic data describing infiltration and exfiltration attempts, denial-of-service attacks, unauthorized scraping, or other misuse or misappropriation of network resources; and labels for the preceding data types, such as annotations indicating whether traffic is legitimate or malicious. The dataset can describe or include packet payloads, metadata such as IP addresses, ports, and protocols, and higher-level features derived from traffic patterns.

A deepfake detection model as described herein can be trained on a secure email gateway dataset, which can include information pertaining to targeted spam botnets, credential phishing, look-alike domains, domain spoofing, fake login pages, phishing URLs, emails with URLs to deepfake phishing sites, malicious message bodies with deepfake and/or malware attachments. Commonly used in phishing attacks, look-alike domains resemble legitimate domains by using slight variations such as misspellings, additional characters, or visually similar characters in the domain name to trick human users into believing they are interacting with a legitimate site and cause them to enter sensitive information such as login credentials, personal data, or payment details. Domain spoofing involves impersonating a legitimate domain, e.g., by manipulating email headers or other communication protocols to make messages appear as though they originate from a trusted source.

A deepfake detection model as described herein can be trained on a model supply chain risk dataset, which can include information pertaining to data poisoning, model theft, and/or model evasion. Data poisoning and model evasion are similar types of attacks, but the former targets a training phase of ML model creation whereas model evasion targets an inferencing phase of an ML model deployed in production. Data poisoning is a type of attack in which an adversary injects misleading or malicious data into a training dataset of an ML model to corrupt the training process, thus altering the model itself. An ML model trained on poisoned data can make inaccurate or biased predictions or classifications and/or can produce biased, offensive, or erratic outputs. Model evasion is a type of attack in which an adversary manipulates inferencing input data to deceive a trained ML model into making incorrect predictions or classifications, without altering the model itself. Model evasion attacks are common in spam detection or fraud detection scenarios. The subtlety possible in data poisoning and model evasion attacks can make them difficult to detect and/or mitigate using conventional automated strategies. Model theft, also known as model extraction, is a type of attack in which an adversary aims to duplicate or replicate an ML model without obtaining possession of the model by systematically querying it with a large number of carefully chosen inputs and analyzing its outputs to extract its original training inputs and/or determine the model's structure, decision boundaries, and/or neural weights.

In the above datasets, data can be categorized and labeled as determined or probable deepfake data or as determined or probable legitimate data. The labeling can be achieved by manual labeling, automated labeling, or a combination thereof.

### Deepfake Detection Model Training and Deployment

FIG. 1 illustrates an example method 100 of deepfake detection model training and deployment, including sources 101 of training data. In 112, training data is collected from the sources 101 of training data, including one or more datastores 102 of media samples of individuals (e.g., enterprise organization executives, personnel, and/or customers), one or more mobile and/or API security platforms 104, one or more bot management platforms 106, one or more web application firewalls 108, and/or one or more email gateway and/or network DLP platforms 110. The training data sources 104, 106, 108, 110 can provide the types of training data related to deepfake indicators of compromise described above, as associated with media files or streams. Media sample datastore(s) 102 can provide additional training data that does not include deepfake indicators of compromise. The data collection, at 112, can be an iterative process that collects new data from sources 101 as new data becomes available to further train and refine a deepfake detection model. In 114, the collected training data can be filtered to pass on only training data determined to be relevant to the deepfake detection model training method 100. Training data not relevant to the deepfake detection model training process 100 can be discarded in the training process by filtering in 114.

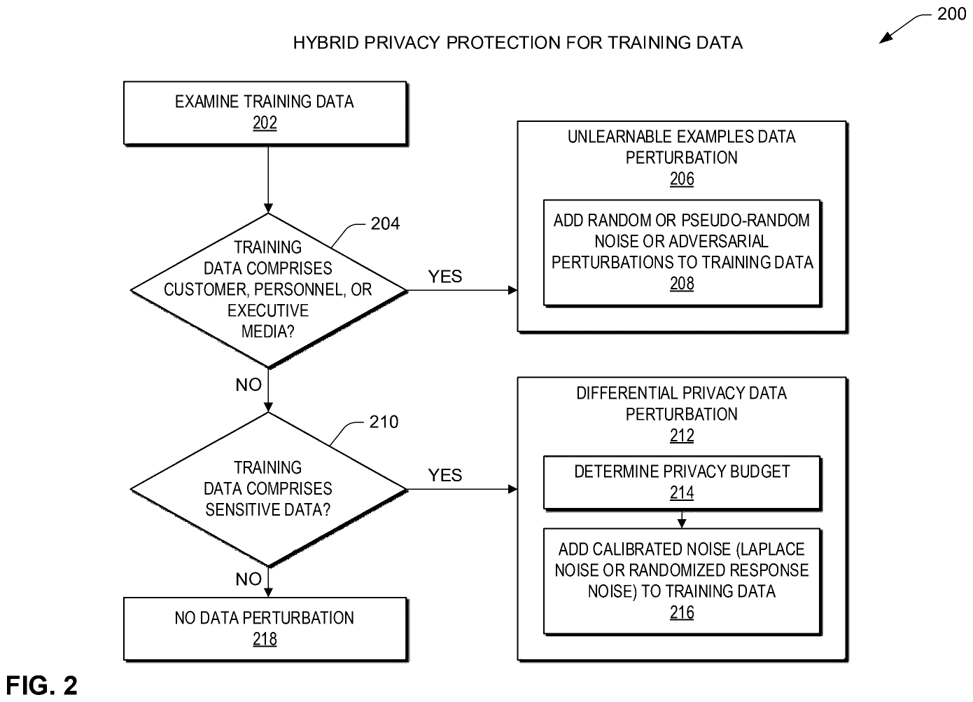

In 116, the collected and filtered training data can further be preprocessed to prepare the training data for the purpose of training the deepfake detection model. As one example of preprocessing in 116, privacy protection measures can be implemented by manipulating the training data. In some examples, one or more differential privacy processes are employed. In some examples, a one or more unlearnable examples processes are employed. In some examples, a hybrid privacy preservation technique combining both differential privacy and unlearnable example processes are employed. An example hybrid privacy preservation process is described below with regard to FIG. 2. After preprocessing in 116, in 118, a deepfake detection model can then be trained on the filtered and preprocessed training data. In 120, the trained model can be deployed in a production environment to detect deepfake data and to take appropriate action based on the detection of deepfake data.

In some examples, in 122, media detected as synthetic by the deepfake detection model can be flagged, e.g., for removal from a social media network, or for suppression from display in a social media network, or for display in a social media network but with the display accompanied by a label or warning or other information indicating that the media is synthetic and potentially misleading. In suppression from display, the detected-deepfake content is not deleted from the social media network, but is reduced or eliminated from being provided in feeds viewed by users of the social media network. In accompanied display, the detected-synthetic media content can be displayed in feeds of users of the social media network, but accompanied by caption text, a watermark, or similar notification alerting a consumer of the media content that the media content is likely synthetic or has been detected to be synthetic. The notification can include a recommendation that that the content not be understood as being real.

In some examples, such as in the context of customer, personnel, or executive interaction with a human or automated agent of an enterprise organization, media detected as synthetic by the trained deepfake detection model can be prevented from use in authentication (either biometric or by verbal or textual provision of authentication information) or for other purposes. As examples, flagging in 122 of a deepfake for distrust can trigger such authentication-use prevention, can trigger communication termination, or can trigger resort to another authentication factor. In some examples, authentication systems can be configured to read a media file or stream deepfake detection flag and prevent the recognized deepfake from being used for authentication or other purposes. Thus, for example, a deepfaked voice would not be accepted as a voiceprint to authenticate a caller to an enterprise organization system, or a deepfaked face would not be accepted to authenticate a videotelephony caller to an enterprise organization system. In some examples, the deepfaked content may be purely textual, and the trained deepfake detection model may be capable of detection of synthetically generated textual content designed to impersonate the textual chat style of an individual.

In some examples, a computer system using the deepfake detection model can be configured to display an alert or notification to a human interactor presently engaged with a detected deepfake (e.g., a call center representative communicating with a deepfaked voice or video stream). The human interactor can thereby be advised not to perform directives requested by the impersonator or grant the impersonator access to sensitive information. In other examples, a computer system can be configured to present an alert or notification to an automated interactor (e.g., a chatbot or AI-powered assistance agent) presently engaged with a detected deepfake. The automated interactor can thereby be advised not to perform directives requested by the impersonator or grant the impersonator access to sensitive information.

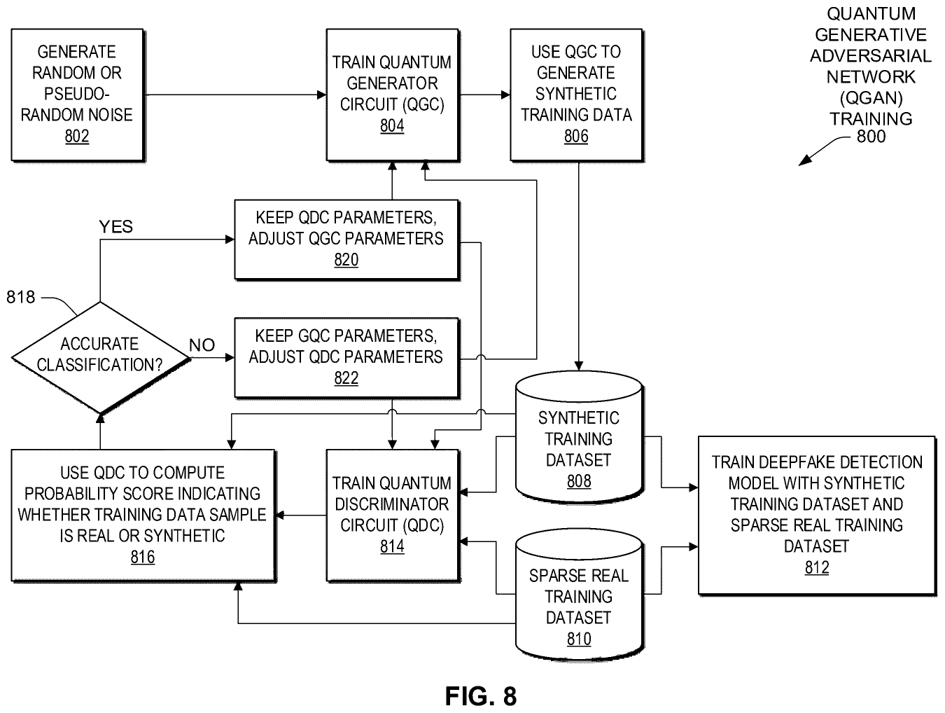

Data from sources 101 can include both positive class data associated with deepfake media and negative class data associated with genuine media. However, because deepfakes may be relatively rare compared to genuine media, the positive class data from sources 101 may be sparse, and in some instances, too sparse to properly train in 118 a media classifier as a deepfake detection model. Accordingly, in some examples, the training in 118 can be augmented with synthetic training data, e.g., intentionally made training deepfakes, generated by a QGAN. The QGAN can be adversarially trained in accordance with a process described in greater detail below with regard to FIG. 8. In 124, the QGAN can generate the synthetic training data and the generated synthetic training data can be provided to train, in 118, the deepfake detection model along with the filtered and preprocessed data from sources 101. The generated synthetic training data can serve as positive-class data to supplement the positive-class data from sources 101, if any.

### Hybrid Privacy Protection for Training Data

Methods for training a deepfake detection model, such as method 100 described above, can include processes that help to preserve privacy of training data used to adjust parameter values in the trained and deployed deepfake detection model. Preservation of privacy in training data can have the benefit of making the trained model more resistant to model theft, that is, to prevent an attacker from recovering privacy-sensitive original training data from the model by querying of the model, even without possession of the model data. In recognition that highly sensitive data may be used in the training method 100, including personally identifying data such as IP address data, email data, phone number data and/or media data such as images, videos, and audio recordings of customers, employees, and/or executives, the training and deployment method can, in some examples, implement a hybrid privacy protection approach for protecting the privacy of training data, the hybrid method combining differential privacy and unlearnable example techniques to enhance privacy in the training process.

FIG. 2 illustrates an example hybrid privacy protection process 200 for protecting privacy of training data used to train a deepfake detection model. The example hybrid privacy protection process 200 can be implemented, for example, at training data preprocessing, in 116, in method 100 of FIG. 1. In some examples, training data preprocessing, in 116, implements only one or the other of the processes illustrated in FIG. 2, that is, only one of differential privacy data perturbation method 212 or unlearnable examples data perturbation method 206.

In 202 of the illustrated hybrid process 200, as training data is processed, individual samples (e.g., individual files or streams) of the training data can be examined to determine what type of data each sample comprises. For example, the different types of data can be (a) sensitive media data depicting or representative of customers, personnel, and executives, (b) otherwise sensitive data, or (c) neither (non-sensitive data). For example, for labeled data, the label of a training data sample or of a collection of training data samples can be compared to known or recognized labels to determine the training data type for the sample. For unlabeled data, a support vector machine, neural network, or deep learning model, trained to classify data into one of the above types, can examine a training data sample or collection of training data samples to determine the type of training data and thereby label the data sample or sample collection for the purposes of process 200.

In 204, it can be determined whether a sample of the training data comprises customer, personnel, or executive media. In 206, based on it being determined that the training data sample comprises customer, personnel, or executive media, an unlearnable examples data perturbation method can be selected to process the training data sample. For example, the customer, personnel, or executive media sample can have been sourced from the media samples of individuals datastore 102 in FIG. 1. As one example, in an unlearnable examples data perturbation method, in 208, random or pseudo-random noise or adversarial perturbations can be added to the training data sample before the deepfake detection model is trained on the training data sample. The random or pseudo-random noise or adversarial perturbations can make it difficult for an attacker to generate a deepfake from the training data sample (the customer, personnel, or executive media) even should the attacker be able to extract the training data sample from the model via model theft or acquisition of the model data, e.g., via exfiltration.

In 210, it can be determined whether the training data sample does not comprise customer, personnel, or executive media, but that the training data sample nevertheless otherwise comprises sensitive data. In 212, based on it being determined that the training data sample does not comprise customer, personnel, or executive media, but that the training data sample nevertheless otherwise comprises sensitive data, a differential privacy data perturbation method can be selected. For example, such training data may include IP addresses, phone numbers, identification numbers (e.g., Social Security numbers), email addresses, or other personally identifiable information (PII), payment card information (PCI), or protected health information (PHI). In 214, the differential privacy data perturbation method can include a determination of a privacy budget for the training data sample examined in 202. In some examples, the privacy budget determination in 214 can be in accordance with a hard-coded or pre-set value. For example, a different privacy budget value can be associated with each sample of training data or with each collection of samples of training data, and can be stored as metadata associated with the training data. In some examples, a support vector machine, neural network, or deep learning model can be trained to assign the privacy budget based on the type or content of the training data sample examined in 202 for the purposes of the hybrid privacy protection process 200.

In 216, the differential privacy data perturbation method in 212 can then add calibrated noise to the training data sample based on the privacy budget determined in 214. As one example, in 216, the differential privacy data perturbation method in 212 can add Laplace noise to the training data. Adding of Laplace noise to the training data sample involves adding noise from a Laplace distribution to the training data sample to obscure individual data points. The amount of noise added can be proportional to the sensitivity of the training data sample and inversely proportional to a privacy parameter that is determined by the privacy budget. As another example, in 216, the differential privacy data perturbation method in 212 can add randomized response noise to the training data sample. By contrast to adding Laplace noise, adding of randomized response noise to the training data sample involves randomly altering sensitive data elements according to a predefined probability mechanism. Both differential privacy noise introduction techniques (Laplace noise and randomized response) can reduce training data utility if the privacy parameter or probability value of the probability mechanism are not well chosen. Accordingly, a privacy budget is determined (e.g., adaptively determined) in 214 and the privacy parameter or probability value is chosen accordingly. The addition of calibrated noise to the training data sample can make it difficult for an attacker to obtain the privacy-sensitive training data sample even should the attacker be able to extract the training data sample from the model via model theft or acquisition of the model data, e.g., via exfiltration.

In 218, in examples where it is determined that the training data sample does not comprise customer, personnel, or executive media and that the training data sample does not otherwise comprise sensitive data, no data perturbation is applied to the training data sample. Thus, in some examples, differential privacy noise can be selectively applied, in 216, only to training data having privacy-sensitive data elements. The amount of noise to be added, in 216, can be increased based on higher a sensitivity of data in accordance with the privacy budget determined in 214. The more privacy-sensitive the training data sample, the greater the privacy budget and the greater the amount of calibrated noise introduced to the training data sample in 216. The lesser the sensitive data elements, the lesser the amount of calibrated noise introduced to the training data sample in 216. The privacy of the highly sensitive data used to train the deepfake detection model can thereby be preserved without too detrimental an effect on deepfake detection model training. In some examples, all of the training data can be deemed to comprise sensitive data of one level of sensitivity or another and data perturbation of one level or another is applied to all training data samples.

### Quantum Advantage for Media Cloaking and Deepfake Detection Model Training and Inferencing

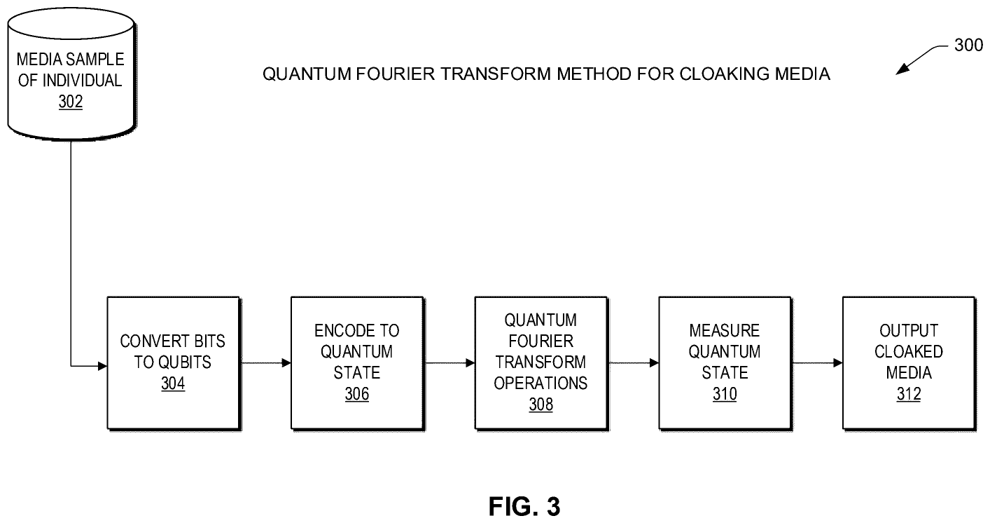

FIG. 3 illustrates an example quantum Fourier transform (QFT) method 300 for cloaking media. QFT method 300 can be used, for example, to implement noise adding in 208 in the unlearnable examples data perturbation method in 206 of the hybrid privacy protection process 200 of FIG. 2. The noise is added in a frequency domain rather than in a temporal, spatial, or spatiotemporal amplitude domain. QFT method 300 can execute faster than classical Fourier transform methods. Whereas the classical Fourier transform increases in computational time exponentially with a linear increase in input media size, a QFT increases in computation time linearly with a linear increase in input media size.

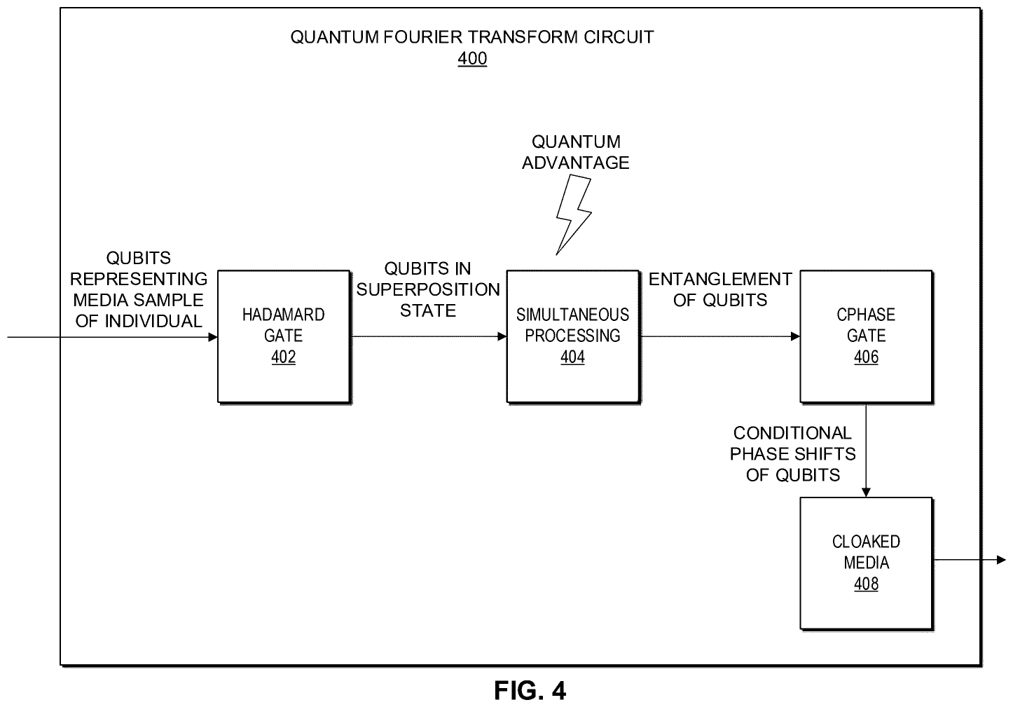

In 302 of QFT method 300, an input media file or stream (e.g., a media sample of an individual, such as a picture, video, or audio recording) can be sourced from a datastore or livestream. In 304, the digital signal of the input media file or stream can be converted from classical bits to quantum bits (qubits). In 306, the qubits of the signal can be encoded to a quantum state. In 308, QFT operations can then be performed that take the quantum-state encoded media data, convert it from its original domain into frequency-domain data, perturb the frequency-domain data, and convert it back to its original domain. An example QFT circuit configured to perform such QFT operations is described below with regard to FIG. 4. In 310, the quantum state is then measured. In 312, the result is output as cloaked media data, wherein frequencies are perturbed, not on a level detectable by human perception, but inhibitive or prohibitive of the use of the cloaked media data as input to an attacker's deepfake creation algorithm. Cloaked media, cloaked using method 300, can be used as training data input to a deepfake detection model (classifier model) to build a more robust classifier. Actions in method 300, such as the QFT operations in 308, can be performed using available quantum computing hardware, e.g., the Quantum Composer platform available from IBM.

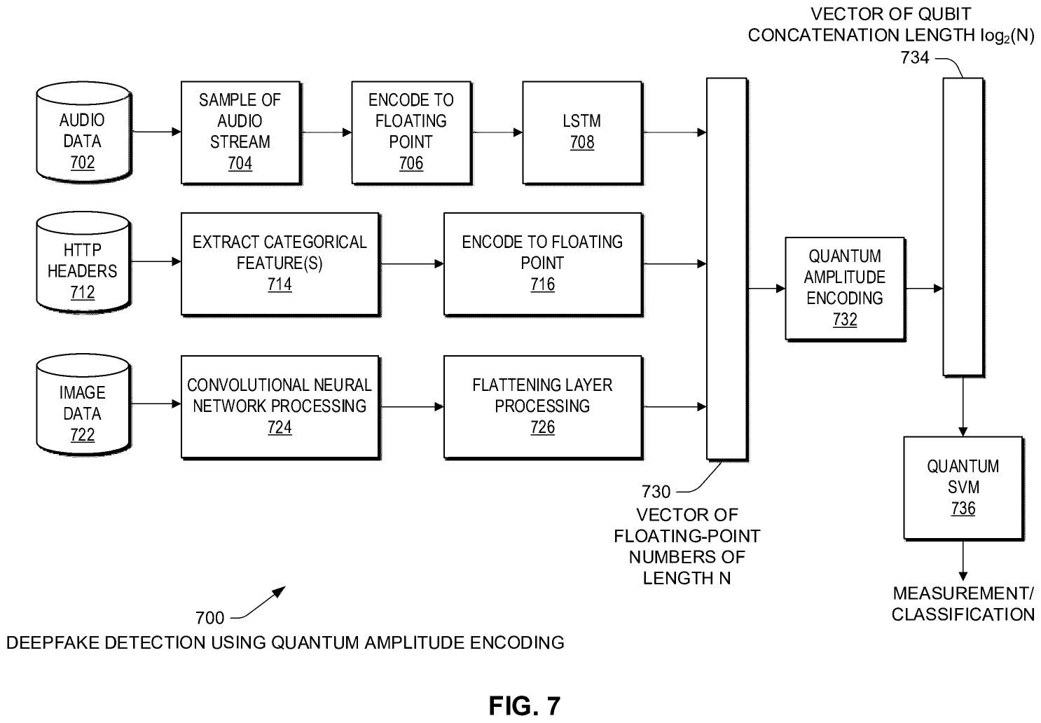

FIG. 4 illustrates an example quantum Fourier transform circuit 400 that can be used to implement QFT operations in 308 in method 300 of FIG. 3. Qubits representing a media sample (e.g., a media sample of an individual) can be provided to a Hadamard gate 402, which outputs qubits in a superposition state. In some examples, amplitude encoding can be leveraged to compress the input media data. For example, an image represented with about one megabyte of data (about 2²⁰ bytes) can be amplitude-encoded and represented using only about 20 qubits. Amplitude encoding of media data is described in greater detail below with regard to FIG. 7. The qubits in a superposition state can then be processed 404, in effect processing multiple parts of the original input media file or stream (e.g., multiple pixels of an image of an enterprise organization executive, and/or multiple samples of an audio recording of a customer telephone call) simultaneously, yielding a quantum processing speed advantage over classical computing methods. The processing 404 outputs an entanglement of qubits which can be provided to a CPhase gate 406. The CPhase gate 406 in turn outputs conditional phase shifts of qubits to result in the cloaked media 408, which can correspond to cloaked media output in 312 in FIG. 3. The cloaked media 408 or cloaked media output in 312 can be resistant to use as an input to a deepfake generator.

Apart from their use in the training of a deepfake detection system, the method 300 of FIG. 3 and/or the quantum circuit 400 of FIG. 4 can also be implemented in media cloaking systems or methods. The method 300 of FIG. 3 and/or the quantum circuit 400 of FIG. 4 can be used to process media files or streams in ways that make them less susceptible to being used, less effective in being used, or impossible to be used in the training of a deepfake generator. When implemented prior to publication of such media files or streams, the method 300 of FIG. 3 and/or the quantum circuit 400 can thereby provide additional security to enterprise organizations with regard to their media such as images, video, and/or audio, for example, media of their customers, personnel, and/or executives, by preventing such media from being used to generate deepfakes, or making it more difficult for such media to be used to generate deepfakes.

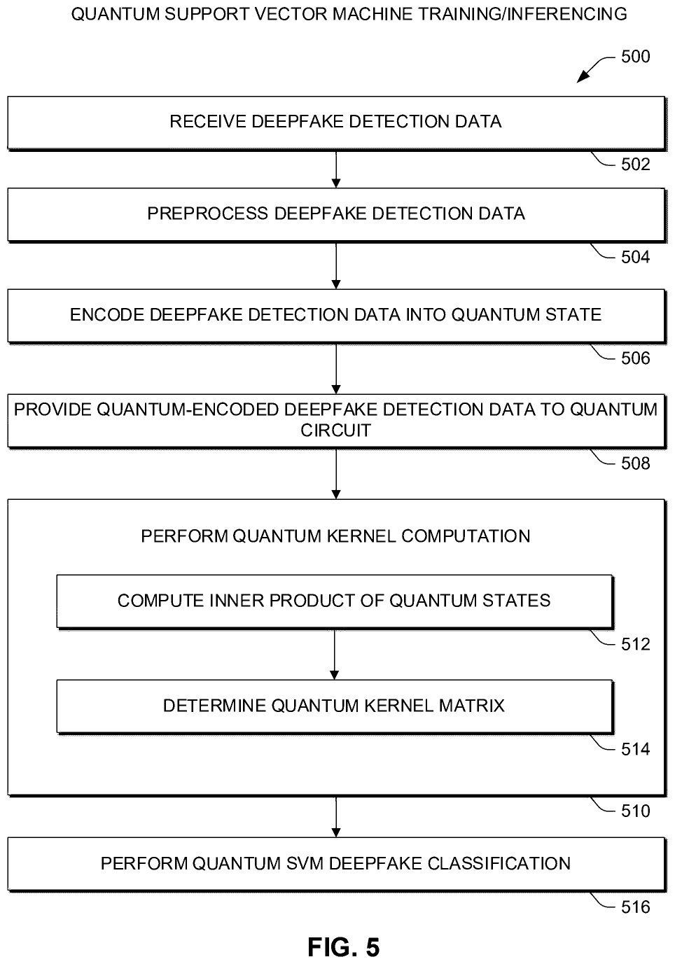

FIG. 5 shows an example method 500 of quantum SVM training and/or inferencing for detecting deepfakes. FIG. 5 highlights quantum computing aspects of the training and/or inferencing, not referenced in FIG. 1, that can be used in some example implementations. Deepfake detection data is received in 502 and preprocessed in 504. The deepfake detection data can be labeled training data used to train a quantum SVM classifier model or can be inferencing data for classification as one of synthetic or genuine by the quantum SVM classifier model. The preprocessing in 504 can be, for example, as described above with regard to FIGS. 1 through 4. The deepfake detection data can be training data or can be provided for input to a trained classifier model for which there is desired a determination as to whether the input represents genuine or deepfake data. In 506, the deepfake detection data, which can include media data and deepfake indicators of compromise data, as described above, can be encoded into a quantum state. For example, quantum amplitude encoding, as described in greater detail below with regard to FIG. 7, can be used as part of the quantum state encoding in 506. In 508, the quantum-encoded deepfake detection data can be provided to a quantum circuit.

In training, parameters of the SVM classifier model can be adjusted based on the quantum-encoded deepfake detection data. For example, in 510, the quantum circuit receives the quantum-encoded deepfake detection data provided in 508 can perform quantum kernel computation on the quantum-encoded deepfake detection data. In 510, quantum kernel computation may include a step in fitting the SVM so that the SVM can be used as a classifier. In the quantum kernel computation in 510, an inner product of quantum states is computed in 512. In 514, the inner product of quantum states is provided as input for determining a quantum kernel matrix. In some embodiments, the quantum kernel computation is not performed during inferencing, after the SVM is trained.

In inferencing (classification), the method 500 can use an SVM classifier model that can be trained as described above with regard to FIG. 1 and/or FIG. 5 as viewed with regard to training. In 516, quantum SVM deepfake classification can be performed using the model. That is, the model can classify whether received deepfake detection data represents deepfake media data or genuine (non-synthetic) media data. The computing the inner product in 512 can be part of the way that the SVM calculates which class an input value falls into. The inner product of states can be computed, in 512, more efficiently for qubits in superposition than for a classical equivalent computation. For example, the classical equivalent computation can take an exponential number of components in the same vector. An inferencing method need not include quantum kernel computation represented in 510.

### Training and Production Deployment Example for Quantum Deepfake Detection

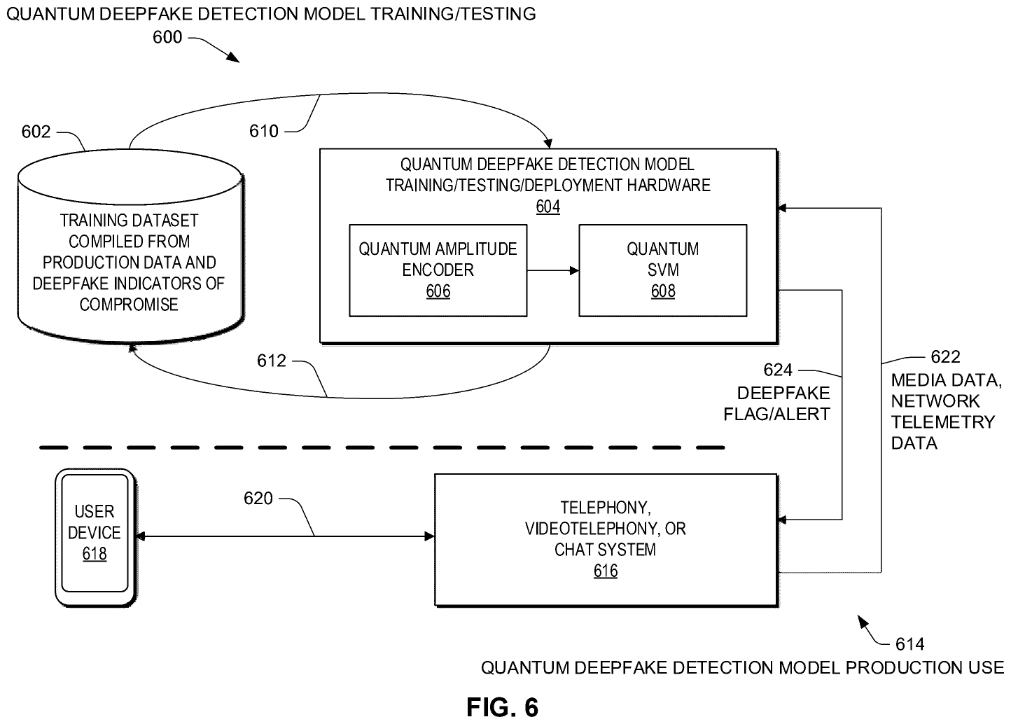

The diagram of FIG. 6 shows training and/or testing process 600 of a quantum deepfake detection model and deployment of the model in production use 614. As described above with regard to FIG. 1, a training dataset 602 can be compiled, e.g., from production data and deepfake indicators of compromise. As described above with regard to synthetic data training in 124 in FIG. 1 and in greater detail below with regard to FIG. 8, the training dataset 602 can also, in some examples, be supplemented with synthetic training data. The training dataset 602 can, for example, be stored in a datastore. Training data in the dataset 602 can be provided, in 610, to quantum hardware 604 for deepfake detection model training and testing. The provided training data can be encoded using quantum amplitude encoder 606, which, in some examples, can function as described in greater detail below with regard to FIG. 7. The encoded training data can then be used to train quantum SVM 608 in an iterative training process. In some examples, the training process can involve labeling of training data, which labeling can be provided, in 612, back to the dataset 602 in the datastore.

Once the quantum SVM 608 is trained, it can be used in production. In an example production use 614 illustrated in FIG. 6, a telephony, videotelephony, or chat system 616 receives data, which can include network telemetry data and media data (e.g., voice, video, and/or chat text data) from a user device 618 via communication connection 620. Communication connection 620 can include, in some examples, one or more networks, such as the internet and/or a cellular communication network. The user device 618 can be any computing device capable of accepting user inputs, communicating with the telephony, videotelephony, or chat system 616 via connection 620, and providing outputs from the telephony, videotelephony, or chat system 616 back to the user. As examples, user device 618 can be a desktop or portable personal computer, a smart phone, a tablet computer, an Internet-of-Things (IoT) connected appliance, a wearable such as a smart watch, a conventional or voice over IP (VoIP) telephone, or a specialized device configured for communication with the telephony, videotelephony, or chat system 616.

As one example, the telephony, videotelephony, or chat system 616 can be used by a customer service call center of an enterprise organization, and user device 618 can be used by a customer of the enterprise organization, or an attacker posing as a customer to commit fraud, to call the customer service call center. As another example, the telephony, videotelephony, or chat system 616 can be an automated or semi-automated textual chat system used as a customer support interface by an enterprise organization, and user device 618 can be used by a customer of the enterprise organization, or an attacker posing as a customer to commit fraud, to chat with the textual chat system.

The media data can include a data stream representative of the content of the call to the call center. The network telemetry data can include information about the hardware of the user device 618, information about software running on the user device 618, information about the communications used by the user device 618 (e.g., IP address or telephone number), geolocation information provided by the user device 618 indicative of the location of the user, or other similar data, as described above with regard to deepfake indicators of compromise data. In some examples, additionally telemetry data can be requested and received from user device 618 by, for example, the telephony, videotelephony, or chat system 616 transmitting a text message (e.g., a short message service (SMS) message) or email message to the user device via connection 620 and requiring the user to click on the link in the text message or email message before proceeding with the call. The clicking on the link can cause the additional telemetry data to be transmitted to the telephony, videotelephony, or chat system 616. The additional telemetry data can include, as examples, an IP address or other types of network parameters that can serve as indicators of compromise, as described above.

The media data and network telemetry data can be provided via connection 622 from the telephony, videotelephony, or chat system 616 to deployment hardware 604 running the trained quantum deepfake deployment model. Although, for purposes of simplicity, the deployment hardware is illustrated in FIG. 6 as being the same as the training/testing hardware, in some examples the deployment hardware can be different than the training/testing hardware, and the trained deepfake detection model can be copied or moved from the training/testing hardware to the deployment hardware as part of a deployment process. The quantum deepfake detection model hardware 604 can quantum-encode the media data and network telemetry data using quantum amplitude encoder 606. The encoding can be performed, for example, as described in greater detail below with regard to FIG. 7.

The quantum deepfake detection model hardware 604 can then process the quantum-encoded media data and network telemetry data using the quantum SVM 608 trained during the training and/or testing process 600 to classify the received media data from the user device 618 as likely deepfake or as genuine (non-synthetic). In the call center example, a classification of the received media data from the user device 618 as likely deepfake can be indicative of the caller being an attacker posing as the customer to commit fraud, and using deepfake techniques to impersonate the customer. Based on classifying the received media data from the user device 618 as being a likely deepfake, the quantum deepfake detection model hardware 604 or an associated computing device (not shown) in communication with the quantum deepfake detection model hardware can generate and transmit a deepfake flag or alert 624 to the telephony, videotelephony, or chat system 616.

In the call center example, the flag or alert 624 can notify a human call center representative or automated system (e.g., a chatbot) that the media data from the user device 618 likely contains deepfake media and the human call center representative can proceed accordingly, or the automated system can be configured to operate accordingly. As one example, the telephony, videotelephony, or chat system 616 can be configured not to accept as genuine any authentication attempt (e.g., any voice or face authentication attempt) from the user device 618 based on the flag or alert 624. As another example, the telephony, videotelephony, or chat system 616 can be configured not to accept any transaction or user account modification instructions from the user device 618, and/or can be configured not to provide any sensitive account information to the user device 618. As yet another example, the telephony, videotelephony, or chat system 616 can be configured to terminate communication with the user device 618. As still another example, the telephony, videotelephony, or chat system 616 can be configured to request another authentication factor from the caller to prove the identity of the caller. For example, the telephony, videotelephony, or chat system 616 may require a fingerprint authentication to be performed by the user device 618 or another device.

The deepfake detection model hardware 604 can also provide 612 the media data and network telemetry data 622 back to the training dataset 602 as training data. The model hardware 604 can periodically re-train the model on newly received data in the dataset 602, resulting in an improved model better able to detect deepfakes without flagging false positives.

Quantum deepfake detection model training/testing/deployment hardware 604 can, in some examples, be a quantum computing resource accessed via a representational state transfer (REST) API. The IBM Quantum Platform, accessible via a web browser, is an example of such a quantum computing resource. API calls to the quantum computing resource can be made to leverage quantum computing in a production environment.

In other examples, rather than the quantum deepfake detection model being deployed to service a telephony, videotelephony, or chat system 616 to detect fraudulent attempts at authentication or authorization, the quantum deepfake detection model can be deployed to service a social network or other media hosting or streaming system to detect hoax deepfake media. Such hoax media can be damaging to individual or corporate reputations, can improperly influence democratic elections, or can foment social unrest, among other dangers. In such examples, the quantum deepfake detection model can be deployed to routinely scan media uploaded to or streamed via the social network or media hosting or streaming system, classifying the media as synthetic or genuine, and flagging any such media classified as synthetic. As described above, media data so flagged can be deleted from the social network or media hosting or streaming system, suppressed on the social network or media hosting or streaming system, or can be accompanied by warnings or other notices when displayed to an end user of the social network or media hosting or streaming system via user device 618. Such examples can otherwise operate consistent with the description provided above with regard to FIG. 6.

### Quantum Amplitude Encoding

FIG. 7 illustrates an example method 700 of deepfake detection using quantum amplitude encoding of data of different types and/or from different sources. In the illustrated example method 700, three types of data are floating-point vectorized and quantum-amplitude encoded for input into a quantum SVM 736: audio data 702, HTTP headers 712, and image data 722. In other examples, more, fewer, or other types of data can be floating-point vectorized and quantum-amplitude encoded. The quantum amplitude encoding illustrated in FIG. 7 can be used to implement any of the training or classification methods described above.

Audio data 702 (e.g., digital audio data representative of a voice of a person, such as in. wav format) can be provided, in 704, as a sample of an audio stream, which can be encoded, in 706, to a floating point format. The floating-point-encoded audio sample can then be processed, in 708, by a long short-term memory (LSTM) neural network architecture configured to convert a large list of floating point numbers into a reduced floating-point representation of the input audio content that can be used for classification. The output of the LSTM in 708 is a single-dimensional vector that can be packed into a feature vector 730.

HTTP headers 712 are presented in method 700 as one example of deepfake indicators of compromise data. Other examples can use additional or different indicators of compromise data, as described above. In example method 700, HTTP headers associated with the audio data 702 and/or image data 722 are first processed, in 714, to extract one or more categorical features from the HTTP headers 712. As one example, CatBoost encoding can be used to extract the categorical features. As other examples, XGBoost, LightGBMk, gradient boosting decision trees (GBDT), or Random Forest methods can be used to extract the categorical features. The extracted categorical features can then be encoded, in 716, to a floating point representation. The output of the encoding in 716 is a single-dimensional vector that can also be packed into feature vector 730.

Image data 722, which, in some examples, can represent a select one or more frames of video data, can be processed, in 724, with a convolutional neural network (CNN) to convert the image data to a multidimensional array of feature data. The output of the CNN can be further processed, in 726, with a flattening layer configured to convert the multidimensional array to a single-dimensional vector of floating point values. This single-dimensional vector can likewise be packed into feature vector 730.

Feature vector 730 in example method 700 is a single-dimensional vector of floating-point numbers that is multimodal for audio data, image data, and indicators-of-compromise metadata (e.g., HTTP headers in the illustrated example). The feature vector 730 is of length N, where N is a positive integer. In 732, the feature vector 730 can be encoded using quantum amplitude encoding to produce a vector of qubit concatenation length log₂(N), which is necessarily less than N. In 732, quantum amplitude encoding can comprise a normalization and an encoding. Aligning with the concept of probability amplitudes in quantum mechanics, the total probability of all outcomes in a quantum system sums to one. Thus, in the normalization, the classical data values in the feature vector 730 can be first normalized so that the sum of the squares of the values in the feature vector 730 equals one. Once normalized, the data values can then be mapped to the amplitudes of a quantum state's basis states. For example, for a normalized dataset vector [a, b, c, d], the values a, b, c, and d can be encoded into the amplitudes of the basis states |00) , |01) , |10) , and |11) of a 2-qubit system.

In 732, quantum amplitude encoding has an advantage of being able to represent an exponentially large amount of data with a relatively small number of qubits. For instance, qubits can represent 2ⁿ data points. For example, by leveraging superposition, four floating-point values can be represented by two qubits in four states simultaneously. In 732, quantum amplitude encoding further has an advantage of quantum parallelism. After data is encoded into a quantum state, e.g., as quantum-amplitude-encoded vector 734, quantum algorithms can process the high-dimensional data of the quantum-amplitude-encoded vector 734 in parallel, potentially offering significant speedups for certain computational tasks over classical computing methods.

In training examples, the quantum-amplitude-encoded vector 734 can be used as training data to train a quantum SVM 736 to detect deepfakes. In classification examples, the quantum-amplitude-encoded vector 734 can be processed by a trained quantum SVM 736 in accordance with the above description to produce a measurement or classification indicative of whether the media represented by the audio data, image data, and indicators-of-compromise metadata (e.g., HTTP headers) is deepfake or genuine media.

### Quantum Generative Adversarial Network Training for Synthetic Media Generation

FIG. 8 illustrates an example method 800 of QGAN training. Method 800 can be implemented, for example, in 124 of FIG. 1 to generate synthetic training data that can supplement training data from sources 101 in FIG. 1. A QGAN in method 800 can comprise a quantum generator circuit (QGC) and a quantum discriminator circuit (QDC). The QGC can be configured to produce synthetic media data that can serve as instances of the positive class for a deepfake detection mode. For example, the QGC can generate synthetic media data (image, audio, and/or video data) that closely resembles a training data distribution. The synthetic media data output of the QGC can be provided to the QDC for evaluation. The QDC can be configured to detect synthetic data. The QDC can differ from the deepfake detection model in that the QDC need not be trained or configured to take into account metadata associated with media data as deepfake indicators of compromise when classifying the media data as real or synthetic. The QGC and QDC can be iteratively trained, alternately against each other in a dialectical relationship, as described below with regard to FIG. 8, until the generated synthetic media data closely resembles the real media data (image, audio, and/or video data) distribution. The synthetic media data set (image, audio, and/or video data) can then be combined with the real media data set for enhanced training 812 of the deepfake detection model.

In 802, random or pseudo-random noise can be generated. In 806, the random or pseudo-random noise can be used to generate synthetic media data by using a QGC. In 804, the QGC can be trained to generate highly realistic synthetic media data (e.g., images) starting only with random or pseudo-random noise. In 808, synthetic media data generated using the QGC in 806 can be saved as part of a synthetic training dataset. At 810, sparse real training data, including genuine instances of media data, can be saved as part of a sparse real training dataset.

In 814, the QDC can be trained, taking as training input both genuine instances of media data from the sparse real training dataset and fake instances of data from the synthetic training dataset. In 816, the trained QDC can be used, for example, to compute a probability score indicating whether a training data sample is genuine (real) or synthetic (fake), or otherwise classifying the input as real or fake.

In different phases of adversarial training method 800 (e.g., at different points in time), either the QGC is trained or the QDC is trained. These phases can happen alternately to successively train and re-train both the QGC and the QDC. The goal of the QGC training phase of method 800 is to train the QGC to produce sufficiently convincing synthetic media output that in effect fools the QDC into assessing synthetic output as genuine. The goal of the QDC training phase of method 800 is to train the QDC to accurately classify as fake instances of synthetic media generated by the QGC, while also accurately classifying as real instances of real media, thus giving no or few false positive identifications of fake media.

In the phase of method 800 in which the QGC is trained, the following process is followed. In 806, the QGC produces synthetic media output. In 808, the synthetic media output is saved to the synthetic training dataset for provision to the QDC. Then, in 816, the QDC makes an evaluation classifying the produced synthetic media as real or fake. For example, the QDC can compute a probability score indicating whether a training data sample is genuine or synthetic. In 818, it is determined whether the QDC made an accurate classification in 816. For example, in 818, it can be determined whether a synthetic training data sample produced by the QGC is accurately classified as synthetic by the QDC in 816. As another example, in 818, it can be determined whether a real training data sample is not inaccurately classified as synthetic by the QDC in 816. Statistically significant accurate classification of a number of samples by the QDC means that the QDC is not fooled by the synthetic media generated by the QGC, and the QGC should therefore be trained to produce more convincing synthetic media to better fool the QDC. In 820, based on the QDC accurately classifying media samples, e.g., based on the QDC accurately classifying synthetic media produced by the QGC as synthetic, the QGC parameters are adjusted and, in 804, the QGC is re-trained based on the adjusted QGC parameters. Also in 820, based on the QDC accurately classifying synthetic media produced by the QGC as synthetic, the QDC parameters are not adjusted and the QDC is not re-trained during the QGC training phase of method 800.

The above-described process can be iteratively repeated in the QGC training phase of method 800. After some training and re-training of the QGC in accordance with the above-described, the QGC may reach of a level of acceptable performance at which it is able to fool the QDC with its synthetic media output for a statistically significant threshold number of synthetic media output instances. At such a threshold point, in 822, the parameters of the QGC can be frozen and the parameters of the QDC can be adjusted. This ends the QGC training phase of method 800 and begins the QDC training phase of method 800.

In the phase of method 800 in which the QDC is trained, the following process is followed. In 806, the QGC can continue to create synthetic media output. In 808, the synthetic media output of the QGC can continue to be saved to the synthetic training dataset for provision to the QDC as training data. In 814 , the QDC is re-trained based on provided fake and real training data and based on the adjusted QDC parameters provided in 822 to better classify real and fake data, e.g., to better identify as synthetic samples of synthetic media input to the QDC with a reduced number of false positives. Then, in 816, the QDC makes an evaluation classifying provided media as real or fake. For example, the QDC can compute a probability score indicating whether a training data sample is genuine or synthetic. In 818, it is determined whether the QDC made an accurate classification in 816. For example, in 818, it can be determined whether a synthetic training data sample produced by the QGC is accurately classified as synthetic by the QDC in 816. As another example, in 818, it can be determined whether a real training data sample is not inaccurately classified as synthetic by the QDC in 816. Statistically significant inaccurate classification of a number of samples by the QDC means that the QDC is fooled by the synthetic media generated by the QGC, and the QDC should therefore be re-trained to better identify as synthetic the synthetic media produced by the QGC. In 822, based on the QDC inaccurately classifying synthetic media produced by the QGC as genuine, the QDC parameters are adjusted and, in 814, the QDC is re-trained based on the adjusted QDC parameters and based on provided synthetic and real training data. Also in 822, based on the QDC inaccurately classifying synthetic media produced by the QGC as genuine, the QGC parameters are not adjusted and the QGC is not re-trained during the QDC training phase of method 800.

Once the performance of the QDC improves to a point at which it is able to accurately detect as fake QDC-generated synthetic media instances for a statistically significant threshold number of such instances, in 820, the QDC parameters can be again frozen and the QGC parameters can be again adjusted to re-enter the QGC training phase of method 800. The QDC and QGC training phases can be iteratively and alternately repeated, thereby iteratively and alternately re-training the QGC and the QDC. The method 800 thus causes each of the QGC and the QDC to improve the performance of the other. Once the QDC is developed to a sufficient level of performance in its output, the QDC can be used to create training data for the quantum SVM (deepfake detection model). In 812, which can correspond to 118 in FIG. 1, the deepfake detection model can be trained with synthetic training data from the synthetic training dataset and with sparse real data from the sparse real training dataset.

Accordingly, in 806, QGAN training method 800 can produce synthetic data to train a more robust QDC classifier in 814 and, separately, to train a quantum SVM deepfake detector in 812. Thus, after the QGC is adequately trained using QGAN training method 800, the synthetic training data generation in 806 can correspond to the synthetic training data generation in 124 FIG. 1. The QGAN-based training of the deepfake detection model in 118 of FIG. 1 can enhance the generalizability of the deepfake detection model by addressing the existing problems that data sets of synthetic media are very sparse or are not specific to customer, personnel, or executive media. QGAN-trained, QGC-generated media can make up for the sparsity of the training data sets. Real customer, personnel, and/or executive media images, video, and/or audio can be input into a QGAN circuit, essentially generating deepfakes, to augment the training data. The use of the QGAN-augmented training data in training the quantum SVM deepfake detection model can ultimately enhance the deepfake detection model performance, resulting in fewer false positives and more accurate predictions as to whether input content is deepfake or real. Because model training is an intensive process, quantum computation can be used for the purpose of efficiency when processing multimodal data.

### Methods, Systems, and Computer-Readable Media for Performing Quantum Deepfake Detection

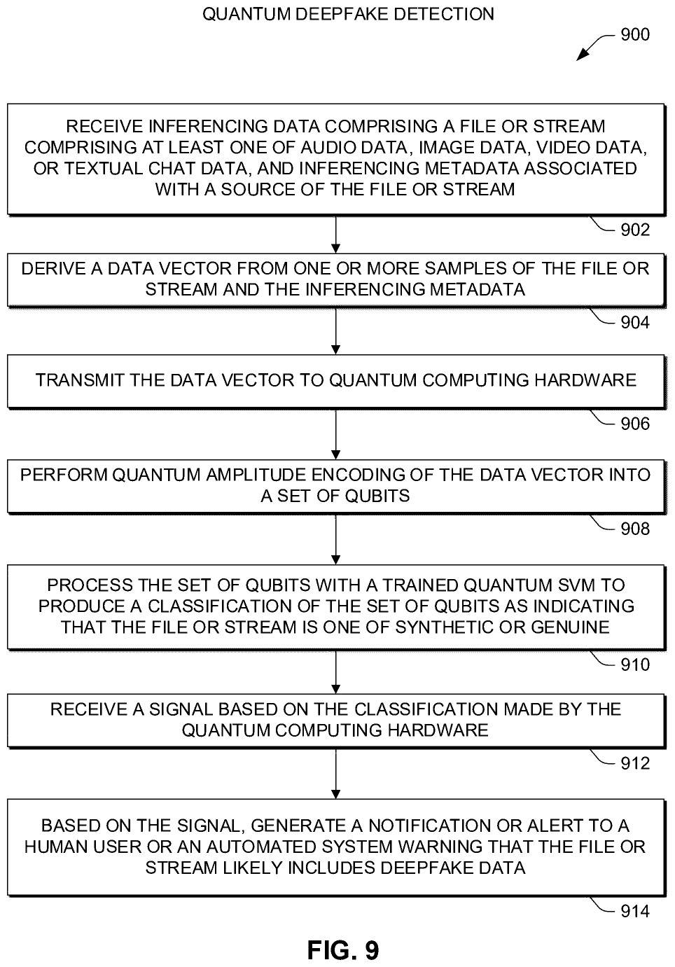

FIG. 9 shows an example computer-implemented method 900 of quantum deepfake detection. In 902, a computer processor receives inferencing data that includes a file or stream including at least one of audio data, image data, video data, or textual chat data. The inferencing data also includes inferencing metadata associated with a source of the file or stream. For example, the inferencing metadata can comprise one or more of the deepfake indicators of comprise described above. As examples, the inferencing metadata can comprise one or more of a dark web threat indicator, an authentication indicator, an authorization indicator, or a bad bot threat indicator. Especially in instances where voice fraud may be involved, e.g., where deepfake voices could be used to circumvent biometric systems, utilization of authentication and/or authorization indicators can be beneficial in deepfake detector model training and inferencing. In some examples, the file or stream is provided from a user device via a network such as the internet. In some examples, the file or stream is sourced from the internet, such as from a website or social media network.

In 904, a data vector is derived from one or more samples of the file or stream and the inferencing metadata. For example, the data vector can be derived as feature vector 730 described above with regard to quantum amplitude encoding method 700 in FIG. 7. In 906, the data vector is transmitted to quantum computing hardware. In 908, the quantum computing hardware is configured to perform quantum amplitude encoding of the data vector into a set of qubits and, in 910, to process the set of qubits with a trained quantum SVM to produce a classification of the set of qubits as indicating that the file or stream is one of synthetic or genuine. In some examples, the quantum SVM is trained on training metadata sourced from various sources of deepfake indicators of compromise as described above. As examples, the training metadata can be sourced from a mobile or API security platform, a bot management platform, a web application firewall, an email gateway platform, and/or a network DLP platform. In some examples, the SVM is trained on media data, with which the training metadata is associated, comprising one or more of image, video, or audio data representative one or more of customers, personnel, or executives of an enterprise organization.

Example method 900 continues in 912 with the computer processor receiving a signal based on the classification made by the quantum computing hardware. The signal can be indicative of the classification made by the quantum SVM. In 914, a notification or alert to a human user or an automated system, warning that the file or stream likely includes deepfake data, is then generated based on the signal indicating that the classification made by the quantum support vector machine is indicative that the file or stream is synthetic. In some examples, based on the signal indicating that the classification made by the quantum SVM is indicative that the file or stream is synthetic, a telephony, videotelephony, or chat system, such as telephony, videotelephony, or chat system 616 in FIG. 6, is configured not to accept an authentication attempt from the user device. In some examples, based on the signal indicating that the classification made by the quantum SVM is indicative that the file or stream is synthetic, a telephony, videotelephony, or chat system is configured to terminate communication with the user device. In some examples, based on the signal indicating that the classification made by the quantum support vector machine is indicative that the file or stream is synthetic, a telephony, videotelephony, or chat system is configured to transmit a request to the user device, the request requiring an authentication factor from a user of the user device to prove an identity of the user of the user device.

Not all steps may be needed to perform implementations of the quantum deepfake detection methods provided herein. Further, some of the steps may be performed simultaneously, or in a different order than shown in FIG. 9. In some examples, a quantum deepfake detection system can include a memory and at least one processor (e.g., a classical-computing processor) coupled to the memory and configured to perform operations comprising operations 902, 904, 906, 912, and 914 of method 900, while permitting a quantum computer to perform operations 908 and 910 of method 900. In some examples, a non-transitory computer-readable device can have instructions stored thereon that, when executed by at least one computing device (e.g., a classical computing device), cause the at least one computing device to perform operations 902, 904, 906, 912, and 914 of method 900, while permitting a quantum computer to perform operations 908 and 910 of method 900.

### Computing Systems Useful in Performing Quantum Deepfake Detection

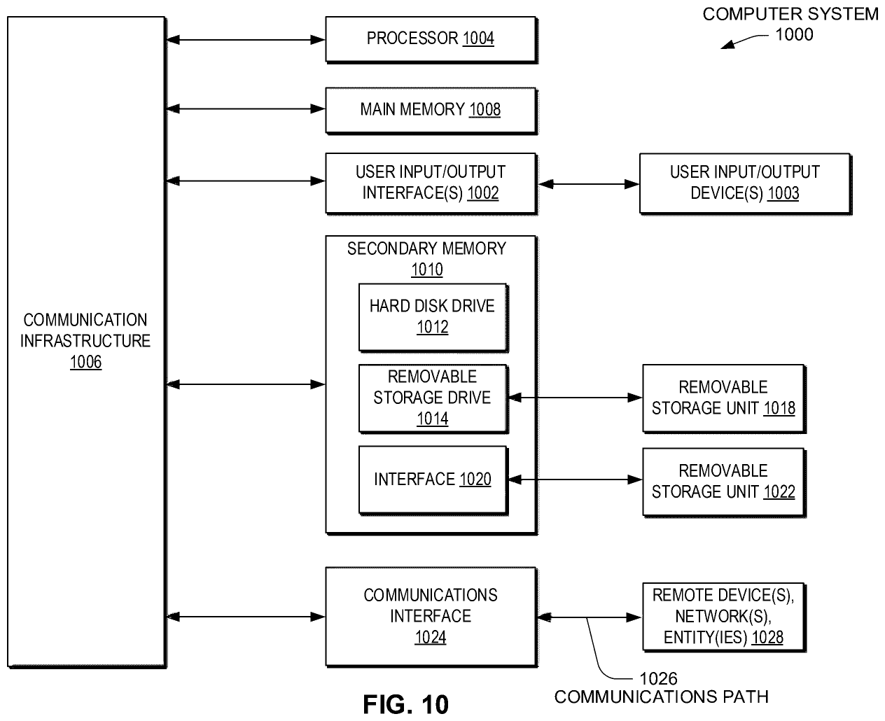

Various embodiments may be implemented, for example, using one or more classical computer systems, such as computer system 1000 shown in FIG. 10. One or more computer systems 1000 may be used, for example, to implement aspects of embodiments discussed herein, as well as combinations and sub-combinations thereof. One or more computer systems 1000 may be used, for example, to implement aspects of the deepfake detection model training method 100, the hybrid privacy protection method 200, preprocessing for quantum amplitude encoding method 700, the user device 618, and/or quantum deepfake detection method 900. Other aspects can be implemented with one or more known quantum computing systems.

Computer system 1000 may include one or more processors (also called central processing units, or CPUs), such as a processor 1004. Processor 1004 may be connected to a communication infrastructure or bus 1006.

Computer system 1000 may also include user input/output device(s) 1003, such as monitors, keyboards, pointing devices, etc., which may communicate with communication infrastructure 1006 through user input/output interface(s) 1002.

One or more of processors 1004 may be a graphics processing unit (GPU), a tensor processing unit (TPU), or an AI processing unit (AIPU). In an embodiment, a GPU, TPU, or AIPU may be a processor that is a specialized electronic circuit designed to process mathematically intensive applications. The GPU, TPU, or AIPU may have a parallel structure that is efficient for parallel processing of large blocks of data, such as mathematically intensive data common to computer graphics or ML applications, images, videos, etc.

Computer system 1000 may also include a main or primary memory 1008, such as random access memory (RAM). Main memory 1008 may include one or more levels of cache. Main memory 1008 may have stored therein control logic (i.e., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 may include a computer usable or readable storage device having stored thereon computer software (control logic) and/or data. Removable storage unit 1018 may be a floppy disk, magnetic tape, compact disk, DVD, optical storage disk, and/any other computer data storage device. Removable storage drive 1014 may read from and/or write to removable storage unit 1018.

Secondary memory 1010 may include other means, devices, components, instrumentalities or other approaches for allowing computer programs and/or other instructions and/or data to be accessed by computer system 1000. Such means, devices, components, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 may further include a communication or network interface 1024. Communication interface 1024 may enable computer system 1000 to communicate and interact with any combination of external devices, external networks, external entities, etc. (individually and collectively referenced by reference number 1028). For example, communication interface 1024 may allow computer system 1000 to communicate with external or remote devices 1028 over communications path 1026, which may be wired and/or wireless (or a combination thereof), and which may include any combination of LANs, WANs, the internet, etc. Control logic and/or data may be transmitted to and from computer system 1000 via communication path 1026.

Computer system 1000 may also be any of a personal digital assistant (PDA), desktop workstation, laptop or notebook computer, netbook, tablet, smart phone, smart watch or other wearable, appliance, part of the internet of things (IoT), and/or embedded system, to name a few non-limiting examples, or any combination thereof.

Computer system 1000 may be a client or server, accessing or hosting any applications and/or data through any delivery paradigm, including but not limited to remote or distributed cloud computing solutions; local or on-premises software (“on-premises” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1000 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 10. In particular, embodiments can operate with software, hardware, and/or operating system implementations other than those described herein.

### Conclusion

Example deepfake detection methods, systems, and computer-readable media can advantageously make use of deepfake indicators of compromise, as described herein, for enhanced deepfake detection. For example, dark web threat indicators, authentication indicators, authorization indicators, and/or bad bot threat indicators can be derived from one or more datasets and incorporated into a training process for a deepfake detector model. The training process can also make use of unlearnable example methods for privacy preservation of sensitive data (e.g., media data) relating to customers, personnel, and/or executives of an enterprise organization during deepfake detector model training. QFT methods can generate cloaked images can serve as an effective protection against deepfake attacks. The training process can also make use of differential privacy methods for further privacy preservation of sensitive data during model training. Example deepfake detection methods, systems, and computer-readable media as described herein can combine unlearnable example methods and differential privacy methods in hybrid privacy protection methods for protecting the privacy of sensitive deepfake detector model training data. Example deepfake detection methods, systems, and computer-readable media as described herein can use quantum kernel method for deepfake detection across multiple modalities of data (e.g., image, audio, video, chat text) and indicators of compromise. Example deepfake detection methods, systems, and computer-readable media as described herein can advantageously use a QGAN to generate enhanced deepfake training data sets and thereby improve deepfake detection model performance. Examples described herein can thus improve over existing deepfake detection models in that they can comprehensively generalize for unknown data sets by using a QGAN for the purpose of augmenting the deepfake training data set and subsequently improving the deepfake detection model performance.

Examples as described herein can combine the various techniques and advantages described above to provide stronger model-training techniques that result in improved identification of deepfakes without compromising privacy and security of training data. As one example, deepfake detection methods and deepfake detector model training methods described herein improve over deepfake detection systems and methods that use combinations of binary classification models and classical generative adversarial networks for the purpose of deepfake detection. As another example, deepfake detector model training data collection and processing methods described herein improve over deepfake classifier training datasets that are based only on publicly available image, audio and video datasets, and which does not take into account a broader set of cyber threat indicators that can enhance deepfake detection and prevention capabilities. As yet another example, quantum computing methods described herein improve over quantum SVM methods for fraud pattern recognition that are not capable of deepfake detection in image, audio and video modalities. As still another example, deepfake detector model training data privacy protection methods described herein improve over systems that lack a comprehensive system that generates deep-fake resistant media as well as detects deep fake media. As still yet another example, deepfake detector model training data as described herein can improve over solutions that do not consider a broader set of cyber threat indicators and deepfake indicators of compromise that can enhance deepfake detection and prevention capabilities. As yet still another example, deepfake detector model training as described herein can improve over solutions that do not utilize unlearnable example methods for preserving privacy during model training. As still another example, deepfake detector model training as described herein can improve over fraud recognition pattern implementations that do not use a quantum SVM for deepfake image, audio and video fraud recognition.

Benefits and advantages of the examples described herein include enhanced protection of an enterprise organization's brand from substantial threats triggered via abusive synthetic media, misinformation, and disinformation. Other advantages of the examples described herein include enhanced deepfake detection capability via a more comprehensive, privacy-preserving training dataset. Additional advantages of the examples described herein include the use of quantum kernel methods for faster deepfake classification model training and inferencing as compared to classical ML methods that may include classical GANs or classical SVMs. Additional advantages of the examples described herein include robustness to adversarial machine learning attacks, stronger generalization across modalities, more interpretable classification of deepfakes, and reduced need for a large amount of labeled data for model training. Still other advantages of the examples described herein include reduced risk of customer identity impersonation, reduced risk of identity theft, reduced voice fraud risk, and reduced financial fraud losses associated therewith.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method of quantum deepfake detection comprising:
receiving, by a computer processor, inferencing data comprising:
content comprising at least one of audio data, image data, video data, or textual chat data, wherein the content is implemented as a file or stream; and
inferencing metadata associated with a source of the content;
deriving a data vector from one or more samples of the content and the inferencing metadata;
transmitting the data vector to quantum computing hardware, wherein the quantum computing hardware is configured to:
perform quantum amplitude encoding of the data vector into a set of qubits; and
process the set of qubits with a trained quantum support vector machine (SVM) to produce a classification of the set of qubits as indicating that the content is one of synthetic or genuine;
receiving, by the computer processor, a signal based on the classification made by the quantum computing hardware; and
based on the signal indicating that the classification made by the quantum SVM is indicative that the content is synthetic, generating a notification or alert to a human user or an automated system warning that the content is classified as including deepfake data.

2. The method of claim 1, wherein the trained quantum SVM is trained on preprocessed training data, preprocessing of the training data comprising:
based on determining that a first sample of the training data comprises customer, personnel, or executive media, performing unlearnable examples data perturbation on the first sample of the training data, the unlearnable examples data perturbation comprising adding random or pseudo-random noise or adversarial perturbations to the first sample of the training data, and
based on determining that a second sample of the training data does not comprise customer, personnel, or executive media, and based on determining that the second sample of the training data comprises sensitive data, performing differential privacy perturbation on the second sample of the training data, the differential privacy perturbation comprising determining a privacy budget for the second sample of the training data and adding calibrated noise to the second sample of the training data, wherein the calibrated noise includes either Laplace noise or randomized response noise.

3. The method of claim 1,
wherein the inferencing metadata comprises at least one of:
a dark web threat indicator,
an authentication indicator,
an authorization indicator, or
a bad bot threat indicator, and
wherein the quantum SVM is trained on training metadata sourced from at least one of:
a mobile or application programming interface (API) security platform;
a bot management platform;
a web application firewall;
an email gateway platform; or
a network data loss prevention (DLP) platform.

4. The method of claim 3, wherein the SVM is further trained on media data with which the training metadata is associated, the media data comprising at least one of image, video, or audio data representative of at least one of customers, personnel, or executives of an enterprise organization.

5. The method of claim 1, wherein the content is provided from a user device via a network, the method further comprising:
based on the signal indicating that the classification made by the quantum SVM is indicative that the content is synthetic, configuring a telephony, videotelephony, or chat system not to accept an authentication attempt from the user device.

6. The method of claim 1, wherein the content is provided from a user device via a network, the method further comprising:
based on the signal indicating that the classification made by the quantum SVM is indicative that the content is synthetic, configuring a telephony, videotelephony, or chat system to terminate communication with the user device.

7. The method of claim 1, wherein the content is provided from a user device via a network, the method further comprising:
based on the signal indicating that the classification made by the quantum SVM is indicative that the content is synthetic, configuring a telephony, videotelephony, or chat system to transmit a request to the user device, the request requiring an authentication factor from a user of the user device to prove an identity of the user of the user device.

8. A quantum deepfake detection system comprising:
a memory; and
at least one processor coupled to the memory and configured to perform operations comprising:
receiving inferencing data comprising:
content comprising at least one of audio data, image data, video data, or textual chat data, wherein the content is implemented as a file or stream; and
inferencing metadata associated with a source of the content;
deriving a data vector from one or more samples of the content and the inferencing metadata;
transmitting the data vector to quantum computing hardware, wherein the quantum computing hardware is configured to:
perform quantum amplitude encoding of the data vector into a set of qubits; and
process the set of qubits with a trained quantum support vector machine (SVM) to produce a classification of the set of qubits as indicating that the content is one of synthetic or genuine;
receiving a signal based on the classification made by the quantum computing hardware; and
based on the signal indicating that the classification made by the quantum SVM is indicative that the content is synthetic, generating a notification or alert to a human user or an automated system warning that the content is classified as including deepfake data.

9. The deepfake detection system of claim 8, wherein the trained quantum SVM is trained on preprocessed training data, preprocessing of the training data comprising:
based on determining that a first sample of the training data comprises customer, personnel, or executive media, performing unlearnable examples data perturbation on the first sample of the training data, the unlearnable examples data perturbation comprising adding random or pseudo-random noise or adversarial perturbations to the first sample of the training data, and
based on determining that a second sample of the training data does not comprise customer, personnel, or executive media, and based on determining that the second sample of the training data comprises sensitive data, performing differential privacy perturbation on the second sample of the training data, the differential privacy perturbation comprising determining a privacy budget for the second sample of the training data and adding calibrated noise to the second sample of the training data, wherein the calibrated noise includes either Laplace noise or randomized response noise.

10. The deepfake detection system of claim 8,
wherein the inferencing metadata comprises at least one of:
a dark web threat indicator,
an authentication indicator,
an authorization indicator, or
a bad bot threat indicator, and
wherein the quantum SVM is trained on training metadata sourced from at least one of:
a mobile or application programming interface (API) security platform;
a bot management platform;
a web application firewall;
an email gateway platform; or
a network data loss prevention (DLP) platform.

11. The deepfake detection system of claim 10, wherein the SVM is further trained on media data with which the training metadata is associated, the media data comprising at least one of image, video, or audio data representative of at least one of customers, personnel, or executives of an enterprise organization.

12. The deepfake detection system of claim 8, wherein the content is provided from a user device via a network, the operations further comprising:
based on the signal indicating that the classification made by the quantum SVM is indicative that the content is synthetic, configuring a telephony, videotelephony, or chat system not to accept an authentication attempt from the user device.

13. The deepfake detection system of claim 8, wherein the content is provided from a user device via a network, the operations further comprising:
based on the signal indicating that the classification made by the quantum SVM is indicative that the content is synthetic, configuring a telephony, videotelephony, or chat system to terminate communication with the user device.

14. The deepfake detection system of claim 8, wherein the content is provided from a user device via a network, the operations further comprising:
based on the signal indicating that the classification made by the quantum SVM is indicative that the content is synthetic, configuring a telephony, videotelephony, or chat system to transmit a request to the user device, the request requiring an authentication factor from a user of the user device to prove an identity of the user of the user device.

15. A non-transitory computer-readable device having instructions stored thereon that, when executed by at least one computing device, cause the at least one computing device to perform operations comprising:
receiving, by a computer processor, inferencing data comprising:
content comprising at least one of audio data, image data, video data, or textual chat data, wherein the content is implemented as a file or stream; and
inferencing metadata associated with a source of the content;
deriving a data vector from one or more samples of the content and the inferencing metadata;
transmitting the data vector to quantum computing hardware, wherein the quantum computing hardware is configured to:
perform quantum amplitude encoding of the data vector into a set of qubits; and
process the set of qubits with a trained quantum support vector machine (SVM) to produce a classification of the set of qubits as indicating that the content is one of synthetic or genuine;
receiving, by the computer processor, a signal based on the classification made by the quantum computing hardware; and
based on the signal indicating that the classification made by the quantum SVM is indicative that the content is synthetic, generating a notification or alert to a human user or an automated system warning that the content is classified as including deepfake data.

16. The non-transitory computer-readable device of claim 15, wherein the trained quantum SVM is trained on preprocessed training data, preprocessing of the training data comprising:
based on determining that a first sample of the training data comprises customer, personnel, or executive media, performing unlearnable examples data perturbation on the first sample of the training data, the unlearnable examples data perturbation comprising adding random or pseudo-random noise or adversarial perturbations to the first sample of the training data, and
based on determining that a second sample of the training data does not comprise customer, personnel, or executive media, and based on determining that the second sample of the training data comprises sensitive data, performing differential privacy perturbation on the second sample of the training data, the differential privacy perturbation comprising determining a privacy budget for the second sample of the training data and adding calibrated noise to the second sample of the training data, wherein the calibrated noise includes either Laplace noise or randomized response noise.

17. The non-transitory computer-readable device of claim 15,
wherein the inferencing metadata comprises at least one of:
a dark web threat indicator,
an authentication indicator,
an authorization indicator, or
a bad bot threat indicator, and
wherein the SVM is trained on training metadata sourced from at least one of:
a mobile or application programming interface (API) security platform;
a bot management platform;
a web application firewall;
an email gateway platform; or
a network data loss prevention (DLP) platform.

18. The non-transitory computer-readable device of claim 17, wherein the SVM is further trained on media data with which the training metadata is associated, the media data comprising at least one of image, video, or audio data representative of at least one of customers, personnel, or executives of an enterprise organization.

19. The non-transitory computer-readable device of claim 15, wherein the content is provided from a user device via a network, the operations further comprising:
based on the signal indicating that the classification made by the quantum SVM is indicative that the content is synthetic, configuring a telephony, videotelephony, or chat system not to accept an authentication attempt from the user device.

20. The non-transitory computer-readable device of claim 15, wherein the content is provided from a user device via a network, the operations further comprising:
based on the signal indicating that the classification made by the quantum SVM is indicative that the content is synthetic, configuring a telephony, videotelephony, or chat system to transmit a request to the user device, the request requiring an authentication factor from a user of the user device to prove an identity of the user of the user device.
